(19) United States
(12) Patent Application Publication
(10) Pub. No.: US 2008/0147611 A1
(43) Pub. Date: Jun. 19, 2008

(54) Meal finder

(75) Inventor: Jeffery Bennett, San Francisco, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/640,069

(22) Filed: Dec. 15, 2006

(51) Int. Cl. G06F 7/06; G06Q 99/00

(52) U.S. Cl. 707/3; 705/1; 707/E17.108

(57) ABSTRACT

Method and system for searching for a meal using the Internet are disclosed. The method includes receiving a user request to search a meal on the Internet, presenting one or more pictures of food dishes to the user, where each picture of a food dish is associated with metadata describing characteristics of the food dish, receiving a user selection, analyzing the user selection according to the characteristics of each food dish presented, and providing additional information to the user according to the user selection.

### FIELD OF THE INVENTION

The present invention relates to the field of Internet applications. In particular, the present invention relates to a method and system for searching for a meal using the Internet.

### BACKGROUND OF THE INVENTION

In recent years, the Internet has been a main source of information for millions of users. These users rely on the Internet to search for information about their interests. One conventional way for users to search for meal-related information is through a local dining guide as shown in FIGS. 1A and 1B. The local dining guide provides a list of restaurants and their corresponding locations on a map, as shown in FIG. 1B and FIG. 1A respectively. The list of restaurants typically displays the name, phone number, address, and user ratings of each restaurant. A user searching for a meal would scan through a long list of restaurants to identify a restaurant to which the user would like to go. Then the user would review the online menu of the restaurant, which typically contains pages of textual description of the dishes offered by the restaurant. The user interface of this conventional method, which requires the user to browse through a list of restaurants and another list of menu items, is complex and hard to use. Both lists of textual information are hard to visualize and unintuitive. As a result, the user would have to spend more time in searching for a meal using this conventional method. Therefore, there is a need for an improved method for searching for a meal using the Internet.

### SUMMARY

The present invention relates to the field of Internet applications. In particular, the present invention relates to a method and system for searching for a meal using the Internet. In one embodiment, a method for searching for a meal using the Internet includes receiving a user request to search a meal on the Internet, presenting one or more pictures of food dishes to the user, where each picture of a food dish is associated with metadata describing characteristics of the food dish, receiving a user selection, analyzing the user selection according to the characteristics of each food dish presented, and providing additional information to the user according to the user selection.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIGS. 1A and 1B illustrate a conventional method of finding a meal on the Internet.

FIG. 2 illustrates a method of assisting a user to select a meal over the Internet according to an embodiment of the present invention.

FIG. 3A illustrates a method of presenting pictures of food dishes to a user according to an embodiment of the present invention.

FIG. 3B illustrates information associated with each picture of a food dish according to an embodiment of the present invention.

FIG. 3C illustrates examples of pictures of food dishes according to embodiments of the present invention.

FIGS. 4A-4B illustrate examples of providing additional information related to a user selection of a food dish according to embodiments of the present invention.

FIG. 5 illustrates a system for assisting a user to select a meal according to an embodiment of the present invention.

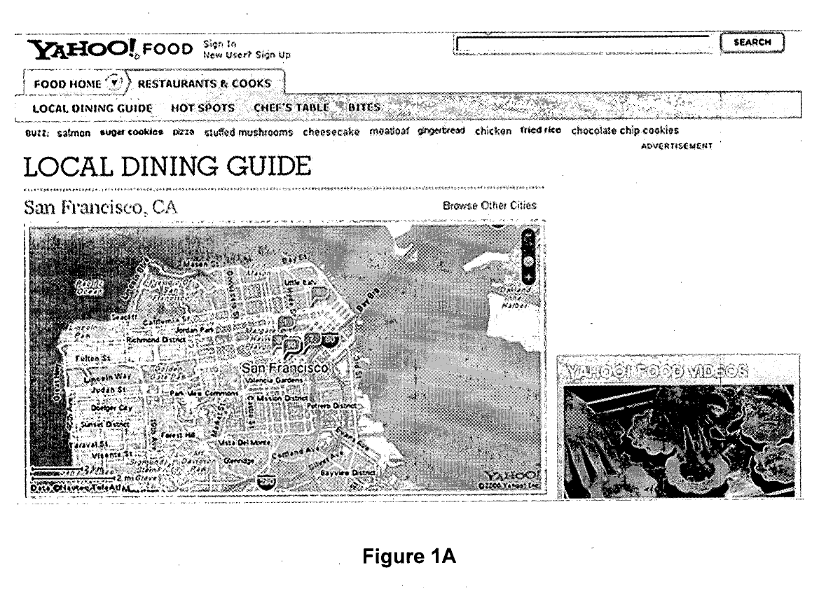

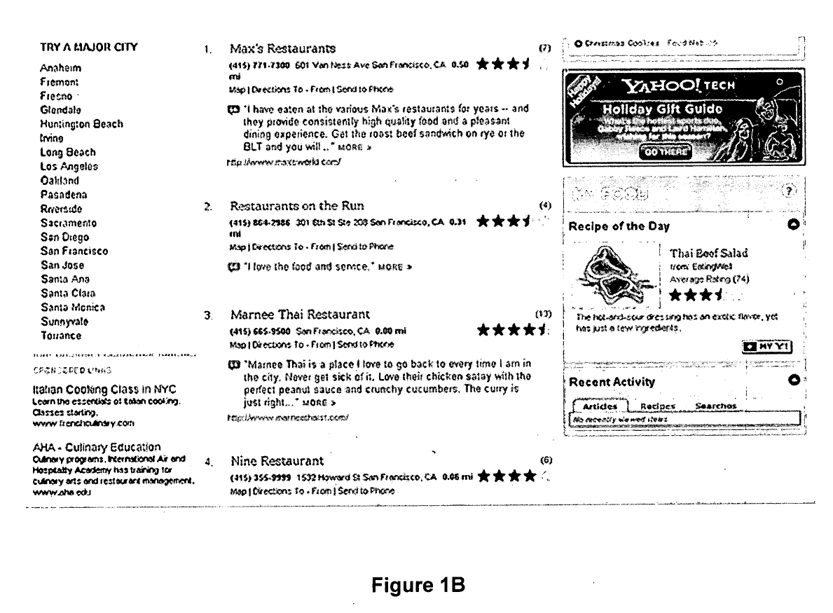

### DESCRIPTION OF EMBODIMENTS

Methods and systems are provided for assisting a user to select a meal. The following descriptions are presented to enable any person skilled in the art to make and use the invention. Descriptions of specific embodiments and applications are provided only as examples. Various modifications and combinations of the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the widest scope consistent with the principles and features disclosed herein.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

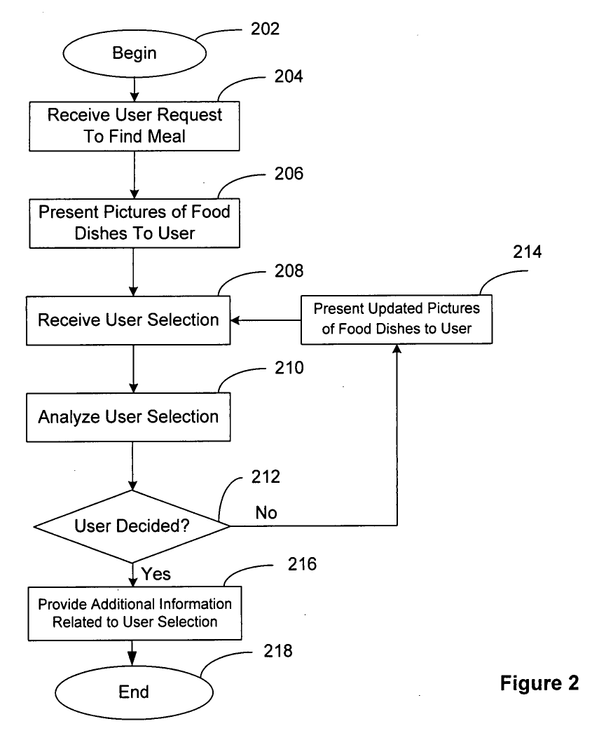

FIG. 2 illustrates a method of assisting a user to select a meal according to an embodiment of the present invention. In general, the method provides a way of selecting a meal, which assists a user to funnel her choices based on the tastes that she derives from viewing pictures of the food dishes, and enables the user to make selections closer to her desired meal while keeping a simple and visual user interface.

Referring to FIG. 2, the method begins in block 202 and thereafter moves to block 204 where the method receives a user request to find a meal. At block 206, in response to the user's request to find a meal, the method presents pictures of food dishes to the user, where each food dish may represent a category of food dishes. In addition, each picture is associated with metadata describing characteristics of the food dish. In some examples of the present invention, the characteristics of a food dish may include saltiness, sourness, sweetness, bitterness, savoriness, spiciness, astringency, leanness, fattiness, tingly numbness, hotness, and coldness. In other examples of the present invention, the characteristics of a food dish may include composition of carbohydrate, protein, fat, vitamin, and minerals in the dish. The method also inquires the user to select a meal that seems most appealing in block 206.

At block 208, the method receives the user's input. At block 210, the method analyzes the user's input according to the characteristics of each food dish presented. The method not only analyzes the one or more food dishes that have been selected by the user, it also analyzes the other food dishes that have not been selected by the user to determine the user's preferences. Based on the results of the analysis, the method is able to bring the user closer to the desired meal.

At block 212, a determination is made as to whether the user has made her selection. If the user has made her selection (212_Yes), the method moves to block 216. In the alternative, if the user has not made her selection (212_No), the method moves to block 214 and presents a set of updated picture of food dishes to the user. The process (blocks 208, 210, 212, and 214) is repeated until the user selects her desired meal. At block 216, the method provides additional information related to the user's selection. For example, the method may provide one or more alternative dishes based on the user selection such that the user is given the choice to replace her selection with one of the alternative dishes.

In another approach, the method may recommend one or more food dishes to complement the user's selection. For example, if the user has selected a main dish, the method may present a salad and/or a dessert to go with the main dish. The method may also recommend beverages or wines to go with the user's selections of the food dishes. Moreover, the method may link the user to websites of restaurants, recipe descriptions, or food markets where the user's selected items may be found. The method ends at block 218.

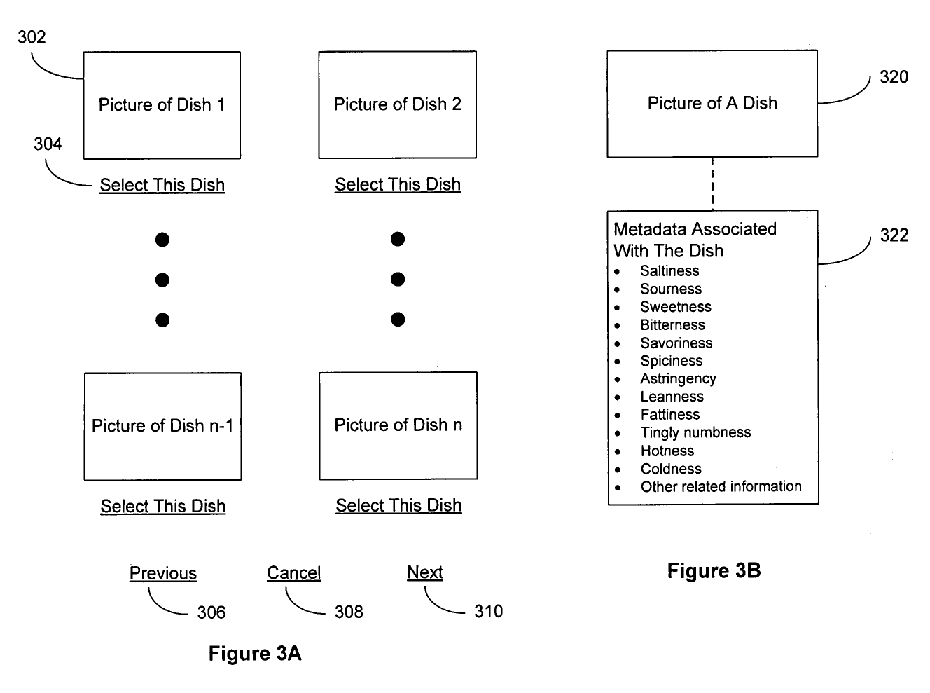

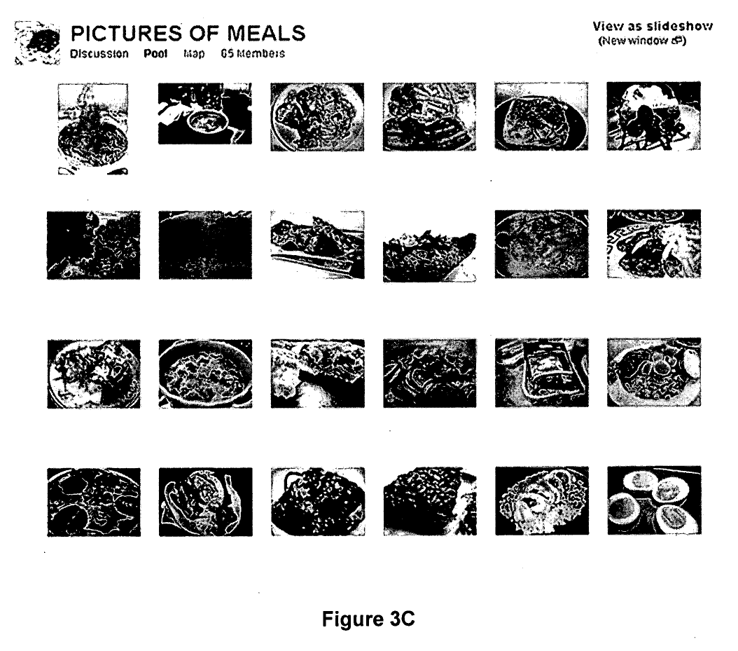

FIG. 3A illustrates a method of presenting pictures of food dishes to a user according to an embodiment of the present invention. In this example, one or more pictures (302) of food dishes are presented to the user. Beneath each picture, a “Select This Dish” button (304) is provided to allow the user to select the particular dish. In addition, a “Previous” button (306) allows the user to view the previously presented pictures of dishes, a “Next” button (310) allows the user the view the next set of pictures of the dishes, and a “Cancel” button (308) allows the user to cancel the whole food selection process. The method provides a simple visual interface for finding a desired meal that the user's appetite craves.

FIG. 3B illustrates information associated with each picture of a food dish according to an embodiment of the present invention. The data associated with a picture of a dish consists of two portions, a content portion (320) that includes the picture of a dish the user sees, and a metadata portion (322) that includes information about the picture that is shown to the user. According to embodiments of the present invention, the metadata associated with a dish may include information describing characteristics of the dish, for example saltiness, sourness, sweetness, bitterness, savoriness, spiciness, astringency, leanness, fattiness, tingly numbness, hotness, coldness, and other related information. The metadata may be stored on a server and is used in finding additional food dishes when the server receives input from the user. FIG. 3C illustrates examples of pictures of food dishes according to embodiments of the present invention.

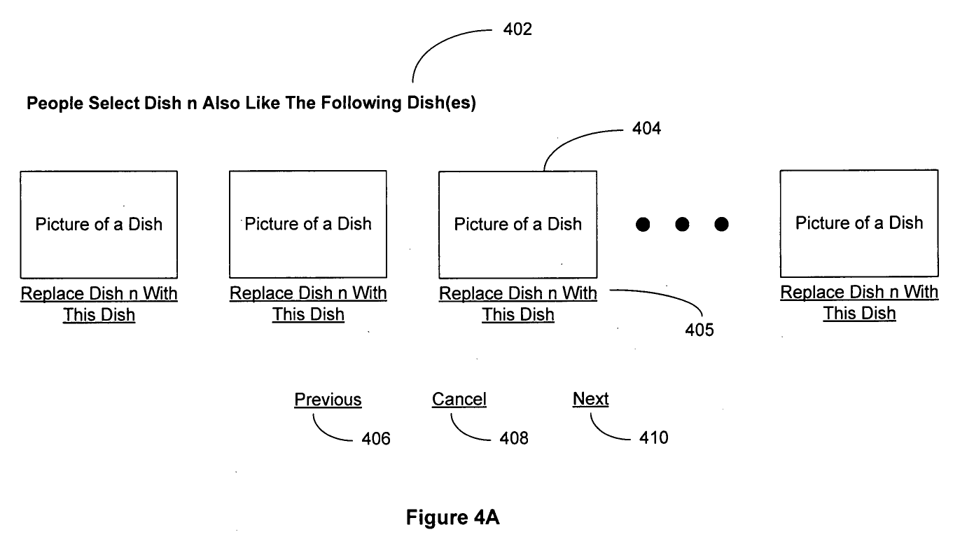

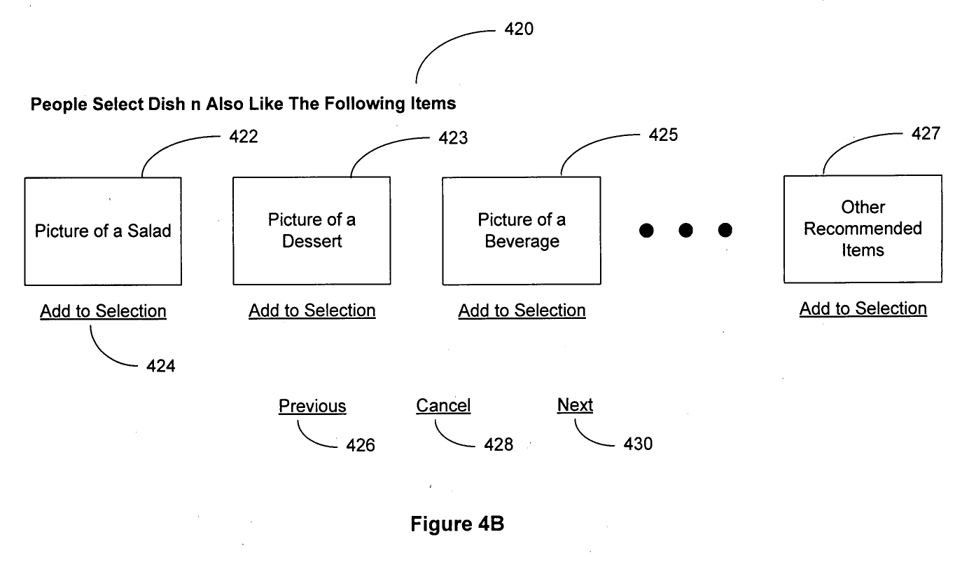

FIGS. 4A-4B illustrate examples of providing additional information related to a user selection of a food dish according to embodiments of the present invention. In the example shown in FIG. 4A, assuming the user has selected Dish n in FIG. 3, the method shows the user one or more alternative dishes (404) with “People Who Selected Dish n Also Like The Following Dishes” sign (402). A “Replace Dish n With This Dish” button (405) is associated with each of the dishes to allow the user to replace Dish n with an alternative dish of her choice. In addition, a “Previous” button (406) allows the user to view the previously presented pictures of the alternative dishes, a “Next” button (410) allows the user the view the next set of pictures of the alternative dishes, and a “Cancel” button (408) allows the user to cancel the viewing of the alternative dishes.

In FIG. 4B, assuming the user has selected Dish n in FIG. 3, the method shows the user one or more items (422) that may be used to complement Dish n. A “People Who Selected Dish n Also Like The Following items” sign (420) is displayed. For example, a salad (422), a dessert (423), a beverage (425), or other recommended items may go well with Dish n. An “Add to Selection” button (424) is associated with each of the pictures to allow the user to add the item to her selection. In addition, a “Previous” button (426) allows the user to view the previously presented pictures of the complementary items, a “Next” button (430) allows the user to view the next set of pictures of the complementary items, and a “Cancel” button (428) allows the user to cancel the viewing of the complementary items.

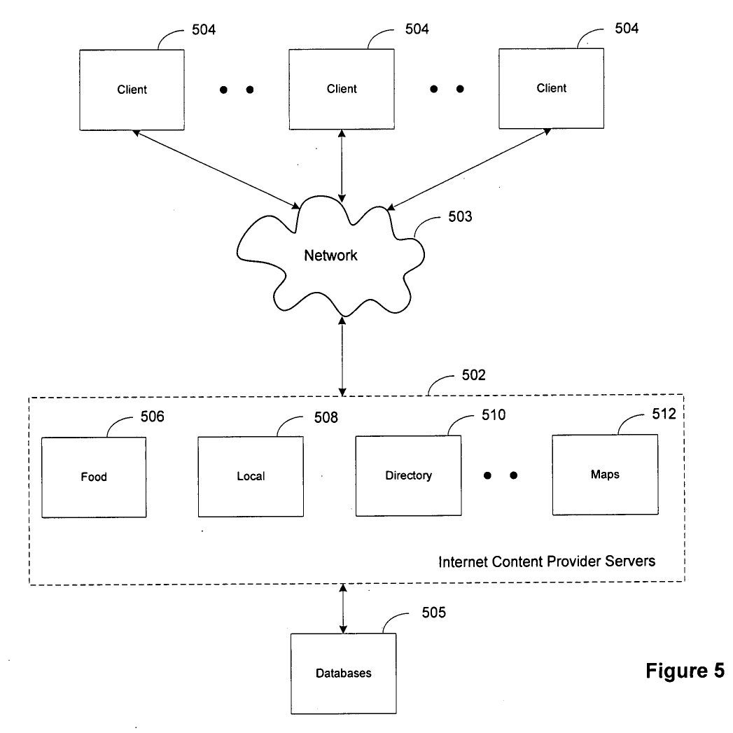

FIG. 5 illustrates a system for assisting a user to select a meal according to an embodiment of the present invention. The system includes one or more Internet content provider servers 502, databases 505, and one or more clients 504. The servers 502 interface with the clients 504 via a communication network 503. The Internet content provider servers 502 are host servers operable to provide content to clients 504 via the network 503. One or more of the servers host websites and include the map functions. The databases 505 are operable to store data provided by the servers 502 and/or clients 504. The databases can communicate with the servers 502 or clients 504 via the network 503. The databases can store data items included in the web pages, such as maps and user information.

Alternatively, the servers 502 may include the databases, processors, switches, routers, interfaces, and other components and modules. Each of the servers 502 may comprise one or more servers, or may be combined into a lesser number of servers than shown, depending on computational and/or distributed computing requirements. The servers 502 may be located at different locations relative to each other. The databases may also be separately connected to the servers 502. There may be more or fewer than two databases, depending on computational and/or distributed computing requirements. The databases may be located at different locations relative to each other and the servers 502.

Each of the clients 504 may be a general-purpose computer, such as a personal computer, having a central processing unit (CPU), a memory, an input device, an output device, and a display. Other computer system configurations, including Internet appliances, hand-held devices, wireless devices, portable devices, wearable computers, cellular or mobile phones, portable digital assistants (PDAs), multi-processor systems, microprocessor-based or programmable consumer electronics, set-top boxes, network PCs, mini-computers, and the like may also be implemented as the clients 504. Each of the clients 504 may also implement analog and digital baseband circuitry, power management circuitry, radio frequency (RF) transceiver, and battery interface and charging circuitry. Clients 504 may include one or more applications, program modules, and/or sub-routines. As an example, clients 504 may include a browser application (e.g., Internet Explorer, etc.) and a graphical user interface (GUI) to access websites and web pages provided by the servers 502 and data stored at the databases 505. Clients 504 may be remote from each other, the servers 502, and/or the databases 505.

The network 503 is a communications network, such as a local area network (LAN), a wide area network (WAN), or the Internet. When the network 503 is a public network, security features (e.g., VPN/SSL secure transport) may be included to ensure authorized access within the system.

The servers 502 further include a plurality of individual domains, for example, Food domain 506, Local domain 508, Directory domain 510, Maps domains 512, etc. A domain is a computer system implemented with different hardware and software for a specific application, such as the shopping applications, news applications, and maps applications. The meal finder application may run on the Food domain 506, which implements Web 2.0 functionalities using a combination of HTML, CSS, JavaScript, and “Asynchronous JavaScript and XML” (AJAX). In particular, JavaScript is used to create, monitor, change, and destroy objects and change the state of the various objects, in addition to keeping track of browser behavior changes initiated by the user.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The invention can be implemented in any suitable form, including hardware, software, firmware, or any combination of these. The invention may optionally be implemented partly as computer software running on one or more data processors and/or digital signal processors. The elements and components of an embodiment of the invention may be physically, functionally, and logically implemented in any suitable way. Indeed, the functionality may be implemented in a single unit, in a plurality of units, or as part of other functional units. As such, the invention may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. A method for searching for a meal using the Internet, comprising:
receiving a user request to search a meal on the Internet;
presenting one or more pictures of food dishes to the user, wherein each picture of a food dish is associated with metadata describing characteristics of the food dish;
receiving a user selection;
analyzing the user selection according to the characteristics of each food dish presented; and
providing additional information to the user according to the user selection.

2. The method of claim 1, wherein each food dish represents a category of food dishes.

3. The method of claim 1, wherein the characteristics of each food dish comprises at least one of the following characteristics:
saltiness, sourness, sweetness, bitterness, savoriness, spiciness, astringency, leanness fattiness, tingly numbness, hotness, and coldness.

4. The method of claim 1, wherein the characteristics of each food dish further comprises at least one of the following information:
composition of carbohydrate, protein, and fat;
composition of vitamins; and
composition of minerals.

5. The method of claim 1, wherein the analyzing comprises:
analyzing characteristics of one or more food dishes that are selected by the user.

6. The method of claim 1, wherein the analyzing further comprises:
analyzing characteristics of previously presented food dishes that are not selected by the user.

7. The method of claim 1, wherein the providing comprises:
recommending one or more food items to complement the user selection.

8. The method of claim 1, wherein the providing further comprises:
presenting one or more alternative food dishes based on the user selection.

9. The method of claim 1, wherein the providing further comprises at least one of the following items:
linking the user to restaurants;
linking the user to recipe descriptions; and
linking the user to food markets.

10. The method of claim 1 further comprising:
presenting updated pictures of food dishes to the user in response to a first request for additional pictures of food dishes; and
presenting previously presented pictures of food dishes to the user in response to a second request for previously presented pictures of food dishes.

11. A computer program product for searching for a meal using the Internet, comprising a medium storing executable program code, the computer program product comprising:
code for receiving a user request to search a meal on the Internet;
code for presenting one or more pictures of food dishes to the user, wherein each picture of a food dish is associated with metadata describing characteristics of the food dish;
code for receiving a user selection;
code for analyzing the user selection according to the characteristics of each food dish presented; and
code for providing additional information to the user according to the user selection.

12. The computer program product of claim 11, wherein each food dish represents a category of food dishes.

13. The computer program product of claim 11, wherein the characteristics of each food dish comprises at least one of the following characteristics:
saltiness, sourness, sweetness, bitterness, savoriness, spiciness, astringency, leanness fattiness, tingly numbness, hotness, and coldness.

14. The computer program product of claim 11, wherein the characteristics of each food dish further comprises at least one of the following information:
composition of carbohydrate, protein, and fat;
composition of vitamins; and
composition of minerals.

15. The computer program product of claim 11, wherein the code for analyzing comprises:
code for analyzing characteristics of one or more food dishes that are selected by the user.

16. The computer program product of claim 11, wherein the code for analyzing further comprises:
code for analyzing characteristics of previously presented food dishes that are not selected by the user.

17. The computer program product of claim 11, wherein the code for providing comprises:
code for recommending one or more food items to complement the user selection.

18. The computer program product of claim 11, wherein the code for providing further comprises:
code for presenting one or more alternative food dishes based on the user selection.

19. The computer program product of claim 11, wherein the code for providing further comprises at least one of the following items:
code for linking the user to restaurants;
code for linking the user to recipe descriptions; and
code for linking the user to food markets.

20. The computer program product of claim 11 further comprising:
code for presenting updated pictures of food dishes to the user in response to a first request for additional pictures of food dishes; and
code for presenting previously presented pictures of food dishes to the user in response to a second request for previously presented pictures of food dishes.
